(19) United States
(12) Patent Application Publication
(10) Pub. No.: US 2007/0127714 A1
(43) Pub. Date: Jun. 7, 2007

(54) Voice-telephone-line multi-point remote access system

(76) Inventors: Jim Patton Ames, Glen Cove, NY (US); Todd Steven Pekats, New Rochelle, NY (US)

Correspondence Address: Todd Steven Pekats, 36 Lakeview Road, New Rochelle, NY, 10804, US

(21) Appl. No.: 11/594,479

(22) Filed: Nov. 8, 2006

Related U.S. Application Data
(60) Provisional application No. 60/736,084, filed on Nov. 11, 2005.

(51) Int. Cl. H04M 1/00; H04M 9/00

(52) U.S. Cl. 379/413.03

(57) ABSTRACT

The Voice-Telephone-Line Multi-Point Remote Access System has more flexibility, portability, and functionality than currently available telephone technologies. The system incorporates the use of a portable digital telephone switch and portable telephone jacks. They are connected using a common network, such as the internet. It allows the use of a traditional phone line from remote, non-predetermined handsets that are connected to the internet, or common network. An incoming call to the telephone line can also be routed to the portable handsets in a non-predetermined fashion. Capabilities also exist for handset to handset communications, also in a non-predetermined location. This present invention is simpler in construction, more universally usable, and more versatile in operation than known apparatus of this kind.

### BACKGROUND OF THE INVENTION

### Field of the Invention

This invention relates generally to a voice telephone line multi-point remote access system and apparatus therefore. Moreover it pertains specifically to such an apparatus for extending residential telephone company voice wiring to multiple non-predeterminable remote locations, by means of interfacing the apparatus to a data network, such as the Internet.

### SUMMARY OF THE INVENTION

In view of the limitations now present in the prior art, the present invention provides a new and useful voice telephone line multi-point remote access system which is simpler in construction, more universally usable and more versatile in operation than known apparatus of this kind.

The present invention generally comprises a portable digital automatic telephone switch, connected to a local telephone foreign exchange station interface, by means of a modular telephone cable, by means of an integrated telephone foreign exchange office interface. The portable digital automatic telephone switch controls one or more remote, portable telephone foreign exchange station to Internet adapters by means of voiceover Internet protocols, by means of a data network connection, such as the Internet, by means of an integrated Internet interface.

Internally, the portable digital telephone switch incorporates integrated systems to automatically perform all of the following functions:

a. A telephone foreign exchange office interface, for connection to a public switched telephone network central office telephone switch, by means of connecting to the foreign exchange station interface/voice telephone jack provided by the telephone company. The theory and operation of a foreign exchange office interface and foreign exchange station interface, as related to its use in a telephone switch, is well understood by those skilled in the art and need not be explained further here.

b. Ethernet interface for a broadband network connection, such as the Internet or a private network, allowing the portable digital telephone switch to establish and control digital voice circuits, by means of voiceover Internet protocols, to remote, portable foreign exchange station to Internet adapters. Ethernet, digital telephone circuit switching, voiceover Internet protocols and foreign exchange station to Internet adapters, as related to their application in digital telephony, are well understood by those skilled in the art and need not be explained further here.

c. Systems for the function of a digital automatic telephone switch, such as one employed by a telephone company for the operation of a telephone exchange, which will not be described further here as those skilled in 3 the art understand the theory, design and capabilities of a digital telephone. switch.

Another component of the apparatus is the DC powered telephone foreign exchange station to Internet adapter which is connected to an analog telephone instrument, by means of a built-in modular phone jack foreign exchange station interface and an Internet network by means of a built-in Internet interface.

Internally, the portable foreign exchange station to Internet adapter incorporates integrated systems to automatically perform at least some, and preferably all of the following functions:

a. A telephone foreign exchange station interface with modular telephone jack for connecting to a standard analog voice telephone instrument.

b. Analog-to-digital and digital-to-analog conversion circuitry for the automatic encoding and decoding of the voice telephone circuit between the digital telephone switch and the portable telephone jack foreign exchange station interface. This need not be described further here as those skilled in the art understand the theory and operation of an analog-to-Internet telephone adapter with built-in telephone foreign exchange station interface.

c. Mechanisms to establish a data network connection with the telephone switch by means of an interconnecting data network and pre-defined 4 addressing, such mechanisms being familiar to those skilled in the art, will not be, described further here.

d. Mechanisms to exchange a shared secret with the telephone switch by means of an interconnecting network, for the purpose of establishing access to the system and call routing determination, such mechanisms being familiar to those skilled in the art.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

In operation, the portable digital automatic telephone switch automatically detects incoming calls on the foreign exchange station interface, by means of monitoring for ring voltage. Therefore, the ring voltage applied to the remote portable foreign exchange station interface to Internet adapter devices, by means of voiceover Internet protocols, by means of an interconnecting network, such as the Internet, by means of the integrated Internet interface, causing all telephones attached to the apparatus to ring. When one of the system controlled telephones is taken off-hook, the incoming telephone call is immediately bridged by the telephone switch onto a digital voice circuit between telephone switch the corresponding remote telephone. Call routing, bridging, and switching as described here are familiar concepts to those skilled in the art.

The portable telephone switch routes outgoing calls from the remote telephone jacks onto the shared telephone line when a telephone instrument that is connected to a remote, portable telephone jack is placed in the off-hook state. The portable jack then signals the telephone switch that access to the shared line is desired. If the telephone switch detects that the shared telephone line is in the off-hook state, the phone switch builds a digital voice circuit to the remote telephone jack and bridges the shared phone line onto the digital voice circuit, such mechanisms being familiar to those skilled in the art.

The telephone switch will return the shared telephone line to the on-hook state when one of the following occur: a remote jack concluding use of the line signals on-hook; a remote jack having use of the shared line can no longer be reached on the data network; dial tone is detected on the shared line but no remote jack has signaled for off-hook.

The described apparatus allows the telephone line that is connected to the portable telephone switch to be time-shared with all telephone instruments connected to the remote, portable telephone-network-interfaces and modular phone jacks, by means of the data network connection between the telephone switch and the remote modular jacks.

### BRIEF DESCRIPTION OF THE DRAWING

The following drawings further describe by illustration the advantages and objects of the present invention. Each drawing is referenced by corresponding figure reference characters within the “DETAILED DESCRIPTION OF THE INVENTION” section to follow.

FIG. 1. is a perspective view of a voice-telephone-line multi-point remote access system in use according to the present invention.

### DETAILED DESCRIPTION OF THE INVENTION

Referring now descriptively to the drawings, the attached figures illustrate a telephone wiring extender device.

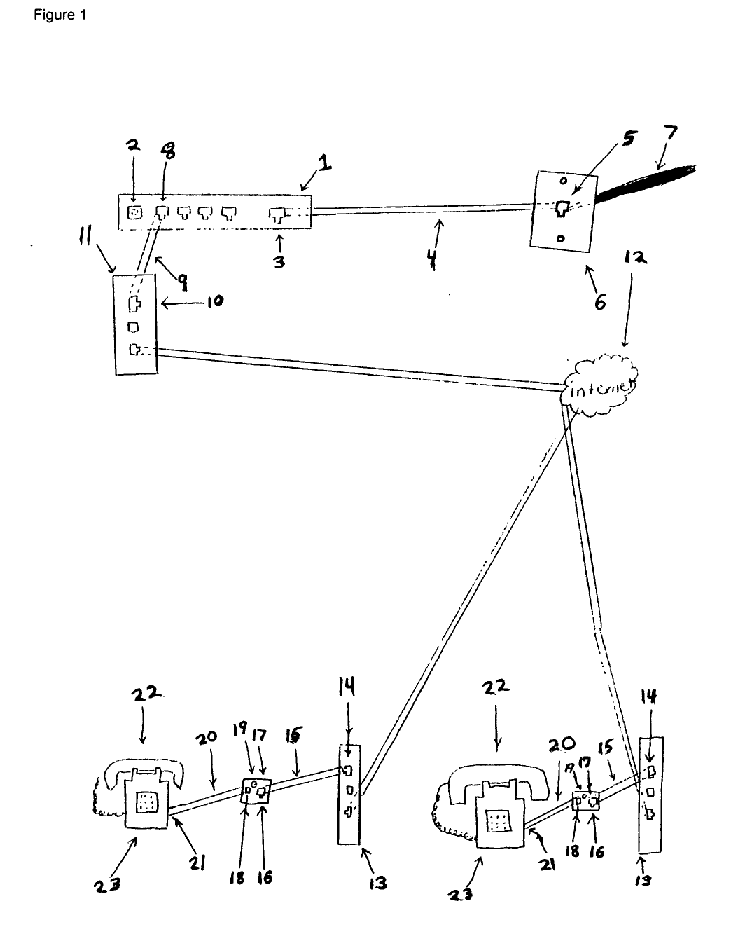

FIG. 1 illustrates a telephone wiring extender device according to the present invention, extending a telephone line across the Internet to telephones in at least two remote locations.

The apparatus includes two components, namely, the portable digital telephone switch 1 and the remote portable telephone jacks 16, interconnected by a common network such as the Internet 12.

The portable digital telephone switch 1 foreign exchange office interface 3 is connected using an RJ11 modular telephone cable 4 to the telephone company RJ11 jack 5 on the foreign exchange station interface 6 provided by the telephone company for providing the telephone subscriber a voice circuit 7 on the public switched telephone network. The portable digital telephone switch 1 is powered by DC electricity 2 and connects to any Internet cable 9 between the digital telephone switch 1 network port 8 and the customer Internet jack 10 on the broadband Internet access device 11.

The remote, portable telephone jacks 16 are geographically located anywhere broadband network access devices 13 are connected to the Internet 12. The customer Internet interface 14 on the remote broadband Internet access device 13 is connected by means of an Internet cable 15 to the Internet port 17 on the remote, portable telephone jack 16. The DC power input 19 energizes the portable telephone jack 16 when connected to DC power. The foreign exchange station jack 18, using an RJ11 cable 20, connects to the foreign exchange office port 21 on the telephone 23.

When a handset 22 on a telephone 23 attached to the remote, portable telephone jack 16 is lifted; the telephone switch 1 allows the shared telephone line 7 to be used from the remote telephone jack 16.

When an incoming call on the shared line 7 is detected by the telephone switch 1, all connected remote, portable telephone jacks 16 will ring the attached telephone 23. The first telephone 23 to take the handset 22 off-hook will be connected to the incoming call.

Those skilled in the art will understand that most any type of network, wired or wireless, or series of interconnected networks, could replace the “Internet” network depicted in FIG. 1, allowing the apparatus to operate just the same without departure from the spirit and intent of the system described.

It will also be understood that, in addition to the telephone wiring extender device, the device can be used to place telephone calls between telephones attached to the apparatus.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

1. We claim that the present invention provides a voice-telephone-line multi-point remote access system device that is improved over existing phone line extenders, such as those operating over household power lines. The remote telephone jack itself is portable outside the house, allowing the telephone jack to be carried from location to location. This remote portable telephone jack, along with the portable telephone switch allows a designated telephone line to ring in many locations at once.

2. Another claim that we make for the present invention is it provides a voice-telephone-line multi-point remote access system device that allows a telephone line connected to a portable telephone switch to be time-shared between multiple remote, portable jacks, by means of a data network connection, such as the internet. This allows a telephone line, such as a subscriber's home or office telephone line, connected to a portable telephone switch, to be accessible from multiple, non-predeterminable locations.

3. We also claim the present invention provides a voice-telephone-line multi-point remote access system device that allows incoming calls on a home telephone line, connected to a portable phone switch, to be answered from any number of remote, data network connected portable telephone-network-interfaces/modular phone jacks. This device is more universally functional in today's market than prior art devices.
It is intended that any other advantages and objects of the present invention that become apparent or obvious from the detailed description or illustration contained herein are within the scope of the present invention.
